(19) United States
(12) Patent Application Publication
(10) Pub. No.: US 2019/0126718 A1
(43) Pub. Date: May 2, 2019

(54) COMPONENT MADE OF A PLASTIC MATERIAL, FOR A HEATING, VENTILATION OR AIR-CONDITIONING DEVICE

(71) Applicant: Valeo Systemes Thermiques, Le Mesnil Saint Denis (FR)

(72) Inventors: Philippe Legros, Le Mesnil Saint Denis (FR); Samuel Escobedo, Le Mesnil Saint Denis (FR); Petr Doskocil, Le Mesnil Saint Denis (FR)

(73) Assignee: Valeo Systemes Thermiques, Le Mesnil Saint Denis (FR)

(21) Appl. No.: 16/094,764

(22) PCT Filed: Apr. 19, 2017
(86) PCT No.: PCT/FR2017/050923

§ 371 Date: Oct. 18, 2018

(30) Foreign Application Priority Data
Apr. 19, 2016 (FR) 1653463

(51) Int. Cl. B60H 1/00

(52) U.S. Cl. CPC B60H 1/00514

(57) ABSTRACT

The invention relates to a component (1) made of plastic material and comprising a side. According to the invention, said side is at least partially in the shape of ascending steps, the rising side of the steps (4, 5) having a thickness (E1) of between 1 and 1.19 mm.

The invention relates to a component made of a plastic material for a heating, ventilating or air-conditioning device, in particular in the field of motor vehicles.

Such known components made of a plastic material are provided with rigidification arrangements.

They can be made up of a wall having a thickness of 1.2 millimeters, provided with reinforcing ribs formed from an excess thickness of 1.5 to 1.7 millimeters on the external face thereof.

They can also be made up of a wall provided with U-shaped ribs on the external face thereof and with a thickness of 1.2 to 1.5 millimeters.

These arrangements have a relatively large thickness, and therefore are relatively expensive in terms of plastic material and therefore have a relatively heavy weight. Moreover, they are not optimized in terms of loss of head and impact on the speed of the air flow, pressure loss and/or aeraulic noise.

The object of the invention is to provide a component made of a plastic material with a high degree of rigidity with regard to torsion and bending stresses, while being especially light.

For this purpose, the invention proposes a component made of a plastic material including a wall, characterized in that this wall is at least partially in the shape of stair steps, in this case ascending, the thickness of the wall at the steps being between 1 and 1.19 millimeters.

In this case, stair steps mean an assembly of steps and risers, the surface of each step being greater than the surface of each riser.

The value range for the thickness of the wall is particularly advantageous for reducing the weight while increasing the stiffness of the component made of plastic, particularly the walls of a heating, ventilating and/or air-conditioning device case. Indeed, the stiffness of a component made of plastic is confirmed by the following formula, R=E×I wherein R is the equivalent stiffness of the rigidity, E being the modulus of elasticity of the material and I being the area moment of inertia (I=b×h³/12, b being the width of the wall, and h being the thickness of the wall). Depending on the material used, it is important to have an area moment of inertia of at least 1 mm⁴ without necessarily excessively increasing the weight of the case. For the majority of the component made of plastic used to form the walls of a heating, ventilating and/or air-conditioning device case, the following table has been produced:

| Thickness of the wall (mm) | Area moment of inertia (mm⁴) |
|---|---|
| 1.5 | 3.38 |
| 1.4 | 2.74 |
| 1.3 | 2.20 |
| 1.2 | 1.73 |
| 1.1 | 1.33 |
| 1 | 1.00 |
| 0.9 | 0.73 |
| 0.8 | 0.51 |
| 0.7 | 0.34 |
| 0.6 | 0.22 |

It is observed, by comparing a case thickness of 1.0 mm and a thickness of 0.8 mm, that there is a difference of 0.2 mm which leads to a decrease of 50% with regard to the area moment of inertia and therefore a stiffness decrease of 50% too (R=E×I). This is the reason for remaining between 1 and 1.2 mm for case wall nominal thickness since this makes it possible to reduce the weight of the case without necessarily compromising the stiffness and rigidity of the case (R≥1). Moreover, there is also an advantage with respect to the manufacture of such a component, and indeed, the smaller the thickness, the more the remaining section for flow of the material is reduced (instantaneous solidifying skin effect for the plastic upon contact with the steel mold), and the greater the thickness, the more plastic material will be required and the slower the flow of the plastic material will be.

According to a preferred embodiment, the thickness of the wall is different depending on the direction thereof.

Preferably, the angle formed by each step and each higher riser is between 50° and 90° and preferably between 70° and 75°.

Advantageously, the angle formed by each step and each higher riser can vary from one step to another.

The thickness of the wall at the steps and the thickness of the wall of each riser is preferably different.

The thickness of the wall at the steps can be substantially equal to 1 millimeter and the thickness of each riser can be substantially equal to 1.5 millimeters.

Preferably, the height of each riser perpendicular to the corresponding step is between 1.5 and 5.5 millimeters.

Advantageously, the tread of each step is between 10 and 50 millimeters and preferably between 30 and 40 millimeters.

Preferably, the height of each riser can vary from one step to another.

The height of each riser advantageously decreases from one step to the following step.

Preferably, the component is made of polypropylene.

The invention also relates to a heating, ventilating or air-conditioning device, in particular in the field of motor vehicles, including such a component made of a plastic material.

The invention is described hereafter in greater detail using figures only showing a preferred embodiment of the invention.

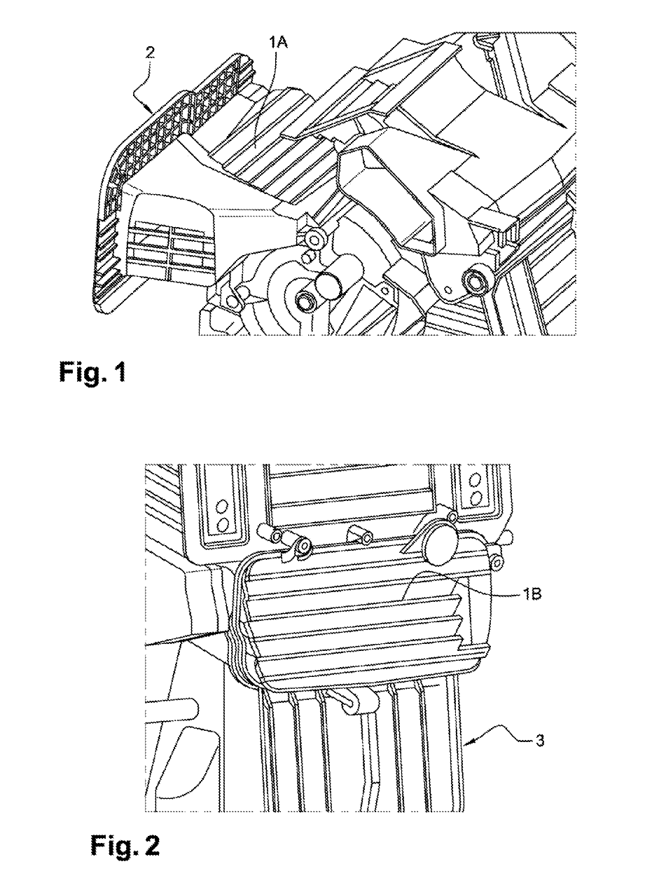

FIGS. 1 and 2 are perspective partial views of a heating, ventilating or air-conditioning device, in the field of motor vehicles.

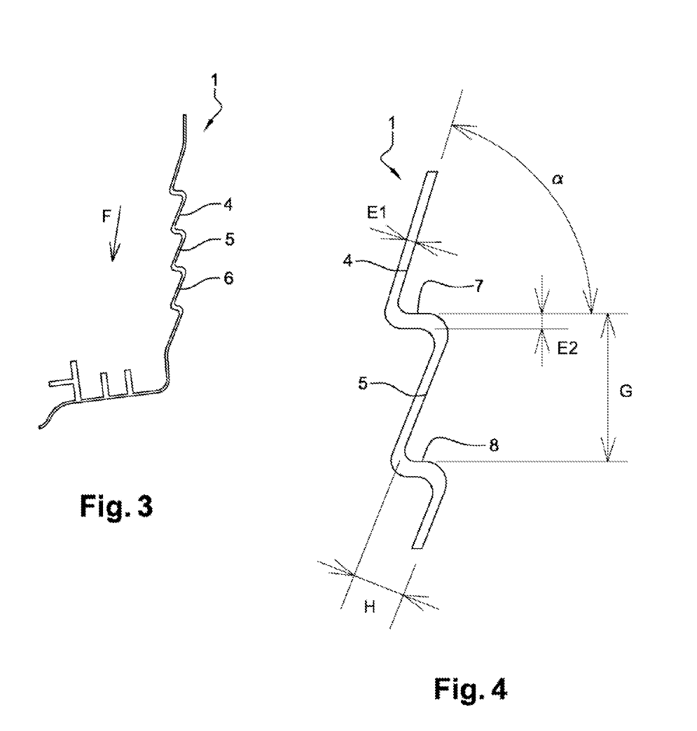

FIGS. 3 and 4 are a sectional view of a component in accordance with the invention.

In FIGS. 1 and 2, a heating, ventilating or air-conditioning device, of a motor vehicle, includes a housing partially made up of a component made of a plastic material 1A, 1B in accordance with the invention. In FIG. 1, this component 1A forms a wall of an air vent 2 and, in FIG. 2, this component 1B forms part of a wall of the housing 3.

This component is shown in section in FIGS. 3 and 4.

This component 1 made of a plastic material, preferably polypropylene, includes a wall, at least partially in the shape of ascending stair steps, the thickness E1 of the wall at the steps 4, 5, 6 being between 1 and 1.19 millimeters, and preferably substantially equal to 1 millimeter.

The angle α formed by each step 4 to 6 and each corresponding riser 7, 8 is between 50° and 90° and preferably between 70° and 75°. This angle α formed by each step (4, 5) and each higher riser (7, 8) can vary from one step to another. The angle α between the steps 4, 7 is 60° and between the risers 5, 8 is 70°, for example.

The height H of each riser 7, 8 perpendicular to the corresponding step is between 1.5 and 5.5 millimeters.

The thickness E2 of each riser 7, 8 is between 1.5 and 1.2 mm.

The tread G of each step is between 10 and 50 millimeters and preferably between 30 and 40 millimeters.

As shown, the height H of each riser 7, 8 can vary from one step to another and more precisely decreases from one step to the following step. The height H of the riser 7 is equal to 2 mm and the height of the riser 8 is equal to 1.5 mm.

Such a component is implemented as follows.

The housing surface to be shaped is divided into elementary surfaces with a surface of approximately 35×90 millimeters, each elementary surfaces being intended to be shaped of a component in accordance with the invention.

The dimensions of the component and of the profile thereof are defined as a function of these elementary surfaces, of the housing demolding direction, of the direction of the air flow in the housing corresponding part and of the direction of the bending stress acting on the surface.

By way of example, in FIG. 3, the air flow is shown by an arrow F.

In general, the risers 7, 8 are perpendicular to the direction of the inner air flow and perpendicular to the bending stress acting on the surface.

1. A component made of a plastic material, comprising:
a wall that is at least partially in the shape of stair steps, a thickness of the wall at the stair steps being between 1 and 1.19 millimeters.

2. The component as claimed in claim 1, wherein the thickness of the wall is different depending on the direction thereof.

3. The component as claimed in claim 1, wherein the angle formed by each step and each higher riser is between 70° and 75°.

4. The component as claimed in claim 1, wherein the angle formed by each step and each higher riser varies from one step to another.

5. The component as claimed in claim 1, wherein the thickness of the wall at the steps and the thickness of the wall of each riser is different.

6. The component as claimed in claim 5, wherein the thickness of the wall at the steps is substantially equal to 1 millimeter and the thickness of each riser is substantially equal to 1.5 millimeters.

7. The component as claimed in claim 1, wherein a height of each riser perpendicular to the corresponding step is between 1.5 and 5.5 millimeters.

8. The component as claimed in claim 1, wherein the tread of each step is between 30 and 40 millimeters.

9. The component as claimed in claim 1, wherein a height of each riser varies from one step to another.

10. The component as claimed in claim 9, wherein the height of each riser decreases from one step to the following step.

11. The component as claimed in claim 1, wherein the component is made of propylene.

12. A heating, ventilating or air-conditioning device for motor vehicles, including a component made of a plastic material as claimed in claim 1.
